(19) United States
(12) Patent Application Publication
(10) Pub. No.: US 2015/0198192 A1
(43) Pub. Date: Jul. 16, 2015

(54) FIXING DEVICE FOR CRANK SENSOR

(71) Applicant: Philippe Van Houtte, Taichung City (TW)

(72) Inventor: Philippe Van Houtte, Taichung City (TW)

(21) Appl. No.: 14/156,953

(22) Filed: Jan. 16, 2014

(51) Int. Cl. F16B 13/06

(52) U.S. Cl. CPC F16B 13/063

(57) ABSTRACT

A device for crank sensor includes a main body, a screw member, and an expanding member. Therein, the main body has a sensing end and a screw end, with a sensed member disposed on the sensing end and a screw hole disposed on the screw end. The screw member has one end with a thread rod and the other end as a fixing end, with an enlarging section disposed in between. The expanding member is inserted on the thread rod and between the enlarging section and the screw end. User needs only to rotate the main body to adjust the distance between the enlarging section and the screw end for varying the radial dimension of the expanding member, whereby the expanding member is fixed on or removed from the bicycle crank.

### BACKGROUND OF THE INVENTION

1. Field of the Invention

The present invention relates to crank sensors installed on a bicycle crank for detecting moving speed, pedaling frequency, revolution speed, and moving distance of bicycles, and more particularly, to a fixing device for crank sensor which is easily installed and removed.

2. Description of the Related Art

For detecting the moving speed, pedaling frequency, revolution speed, and moving distance, an ordinary bicycle is provided with a displayer and a detecting device on the bicycle frame, and also provided with a sensed member on the crank for revolving in accordance with the crank, whereby the detecting device identifies the times of the sensed member passing by and thus calculates the moving speed, pedaling frequency, revolution speed, and moving distance of the bicycle.

Regarding a crank sensor disclosed by patent U.S. Pat. No. 4,636,769, a revolution detecting portion is disposed on the main body of a bicycle, with a magnet base disposed on the crank. Through the revolution duration and times detected by the revolution detecting portion, running speed, distance, and other statistics are thus identified.

Therein, the magnetic base is fixed on the middle section of the crank by a band, mainly for preventing the magnet base from detaching during pedaling and causing an incorrect detection. The band is required to be tightly fastened on the middle section of the crank, whereby the position of the magnet base is not allowed to be adjusted once the band is tightly fastened. To adjust the position of the magnet base, the original band is needed to be cut up and replaced with a new band for fixing the magnet base at the correct position again.

Also, fixing the magnet base on the crank with a band affects the aesthetic appearance of valuable high end bicycles. As a result, an improvement of the fixing device for crank sensor is needed.

### SUMMARY OF THE INVENTION

For improving aforementioned difficulties, the present invention discloses fixing device for crank sensor, which is convenient for installation and maintenance, and at the same time suitable for being installed on a wide range of bicycles.

The present invention provides a fixing device for crank sensor, comprising:

a main body, provided with a sensing end and a screw end, with a sensed member disposed on the sensing end and a screw hole axially disposed on the screw end;

a screw member, with one end thereof provided with a thread rod screwing in the screw hole and the other end provided as a fixing end, while an enlarging section is disposed between the thread rod and the fixing end; and

an expanding member, inserted on the thread rod and between the enlarging section and the screw end.

The primary objective of the present invention is to provide a fixing device for being installed on a bicycle crank with a pedal, while the pedal is pivotally disposed on one end of the crank by use of a revolving axle, which is concavely provided with a tool hole. Therein, the fixing end of the screw member and the expanding member are allowed to be received in the tool hole, and the fixing end is coupled in the tool hole to produce a revolution limitation. When the main body revolves, the distance between the enlarging section and the screw end varies, whereby the enlarging section presses and drives the expanding member to be enlarged. As a result, the radial dimension of the expanding member is enlarged, whereby the expanding member is thus fixed in the tool hole.

The secondary objective of the present invention is to provide the radial dimension adjustability of the expanding member by use of the cooperation between the expanding member and the enlarging section, whereby the present invention is convenient for repeatedly installation and removal. Therefore, the maintenance of the device is facilitated, and the aesthetic appearance of the bicycle is also maintained, thus increasing the quality and added value of the bicycle.

### BRIEF DESCRIPTION OF THE DRAWINGS

FIG. 1 is a perspective view of the fixing device for crank sensor in accordance with the present invention.

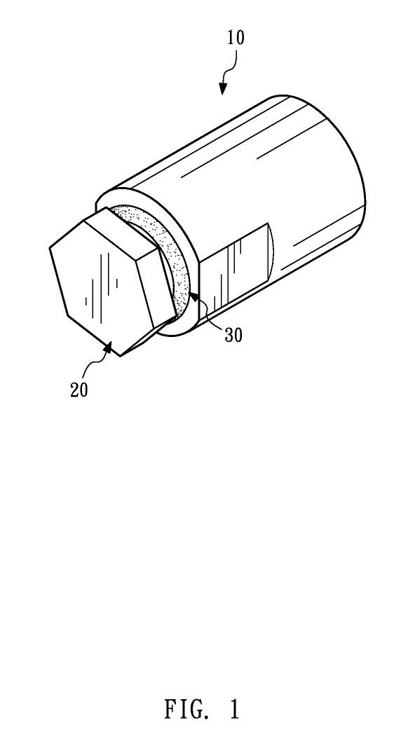

FIG. 2 is an exploded view of the fixing device for crank sensor in accordance with the present invention.

FIG. 3 is a schematic view illustrating an embodiment in accordance with the present invention.

FIG. 4 is a schematic view illustrating the status of installation in accordance with the present invention.

FIG. 5 is another schematic view illustrating the status of installation in accordance with the present invention.

FIG. 6 is an exploded view of another embodiment of the fixing device for crank sensor in accordance with the present invention.

### DETAILED DESCRIPTION OF THE INVENTION

Other and further advantages and features of the present invention will be understood by reference to the description of the preferred embodiment in conjunction with the accompanying drawings where the components are illustrated based on a proportion for explanation but not subject to the actual component proportion. Also, similar components are marked with the same numbers.

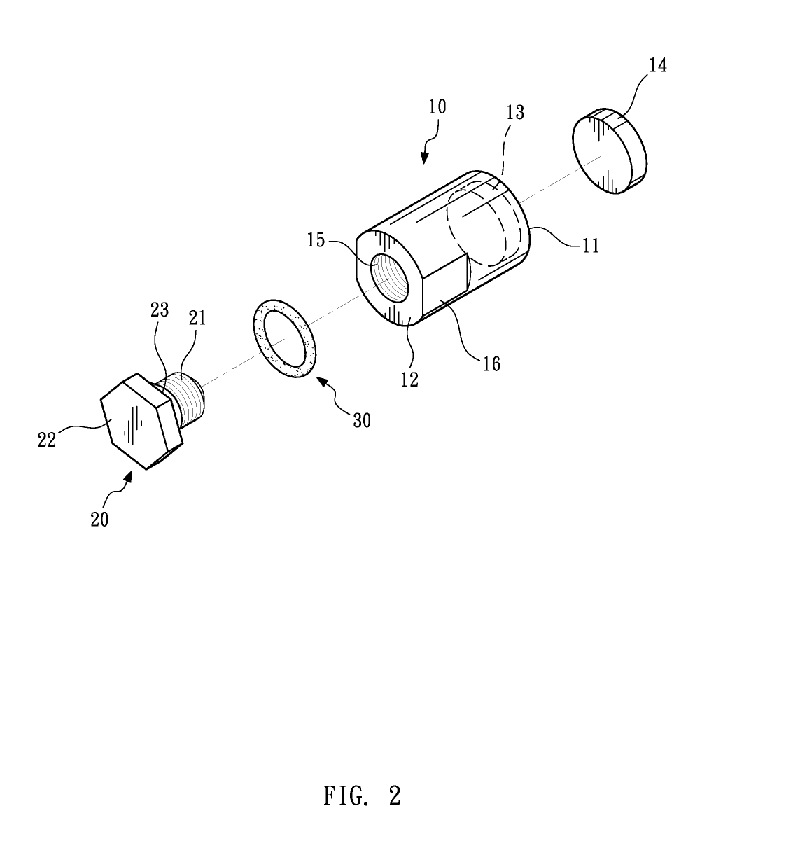

Referring to FIG. 2 to FIG. 5, the fixing device for crank sensor provided by the present invention comprises a main body 10, a screw member 20, and an expanding member 30.

The main body 10 is provided with a sensing end 11 on one end and a screw end 12 on the other end, with a recess 13 concavely disposed on the sensing end 11 for receiving a sensed member 14, while the sensed member is a magnet or similar object capable of being sensed, wherein a screw hole 15 is axially disposed on the screw end 12, and at least a pair of operating faces 16 are disposed in parallel on two sides of the main body 10.

The screw member 20 has one end presented as a thread rod 21 capable of being screwed into the screw hole 15 and the other end presented as a polygonal fixing end 22, which can be a hexagonal shape. Therein, an enlarging section 23 is disposed between the thread rod 21 and the fixing end 22, and the radial dimension of the enlarging section 23 is gradually enlarged in accordance with the direction from the thread rod 21 toward the fixing end 22.

The expanding member 30 is inserted on the thread rod 21 and between the enlarging section 23 and the screw end 12, wherein the expanding member 30 is a resilient ring, such as an ordinary O-shaped ring made of plastic, rubber or other resilient materials.

The structural detail of the present invention is introduced, and the method of operation of the present invention is described below.

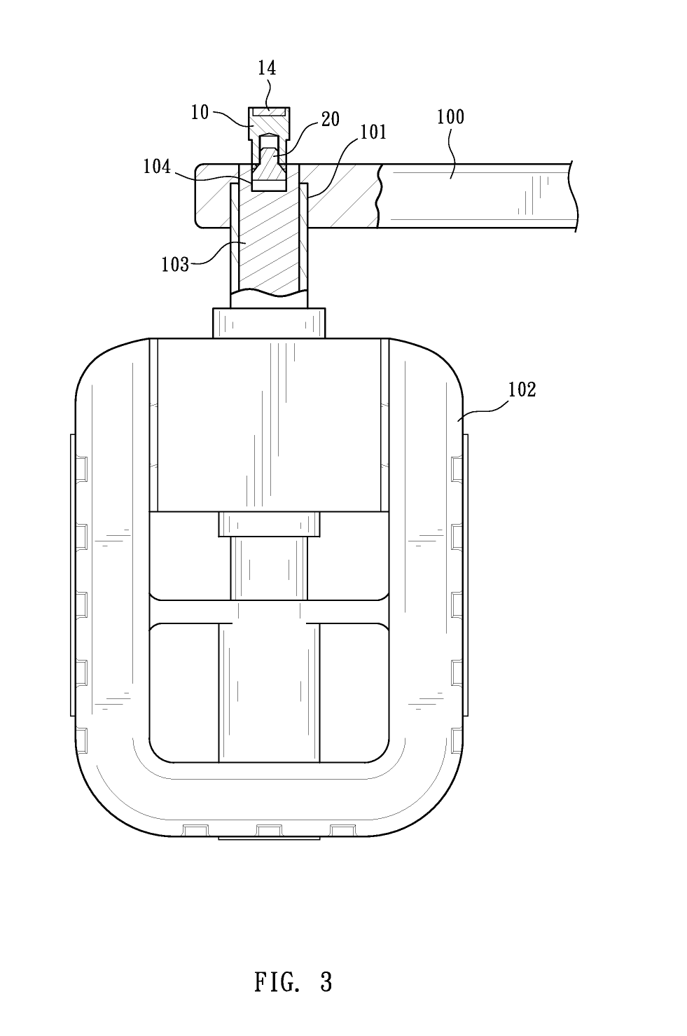

Referring to FIG. 3, the present invention is installed on a bicycle crank 100. One end of the bicycle crank 100 is provided with a screw hole 101 for receiving an axis 103 of a pedal 102. Therein, one end of the axis 103 is provided with a tool hole 104 which is normally present as a hexagonal hole for moveably coupling a tool such as a wrench, whereby the axis 103 of the pedal 102 is allowed to be installed on or removed from the screw hole 101.

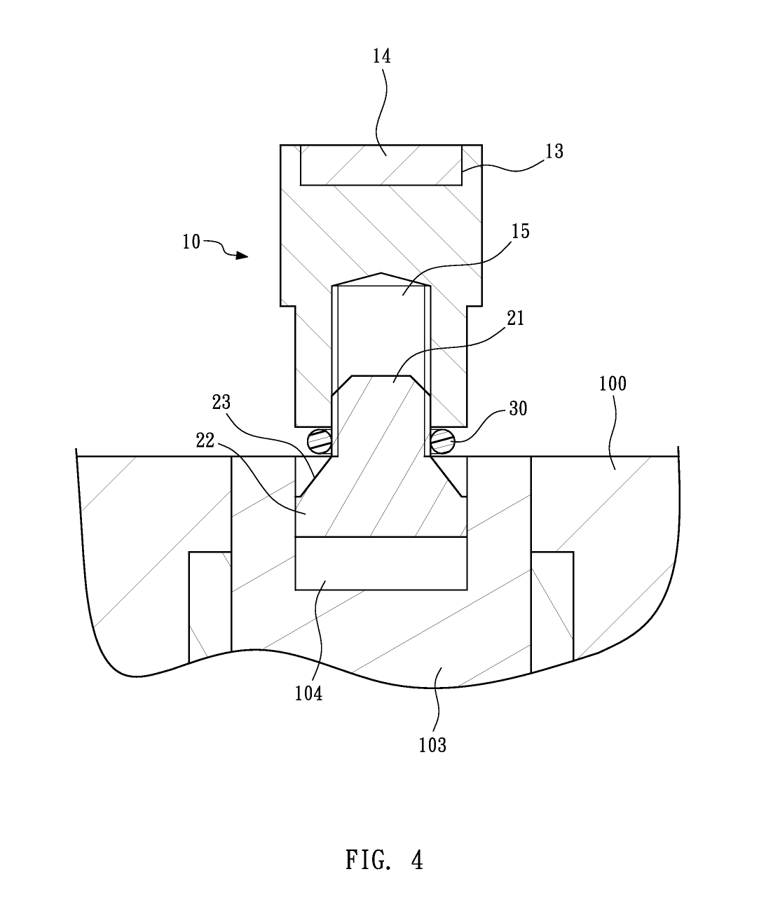

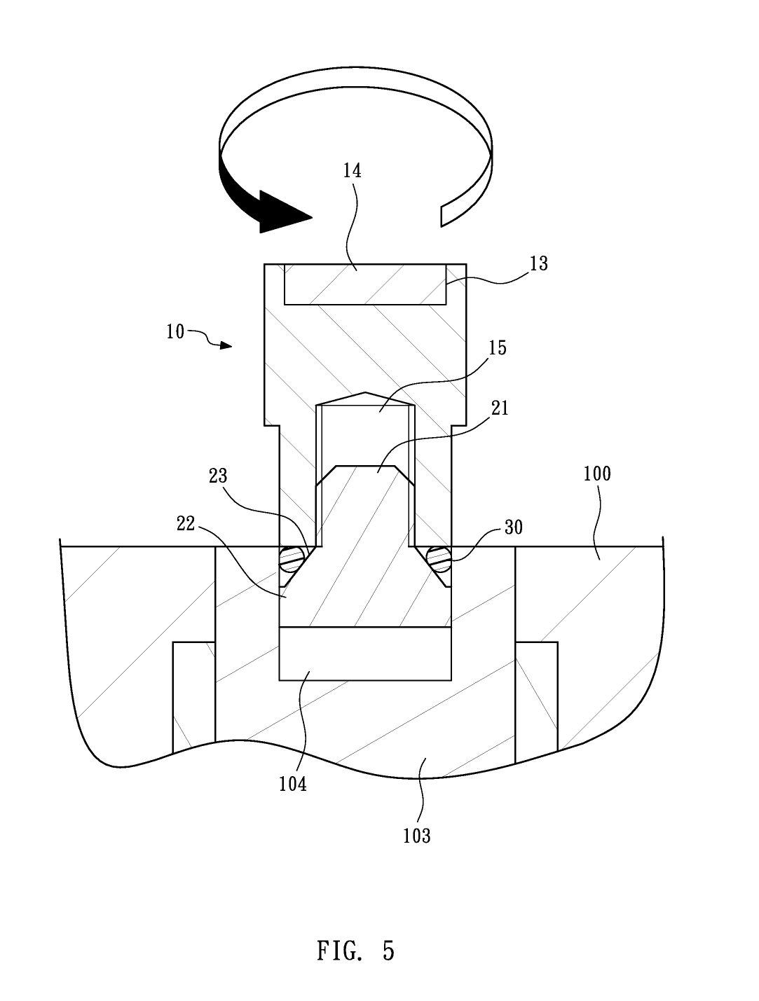

Referring to FIG. 4, during installation, because of the shape of the fixing end 22 of the screw member 20 is designed in correspondence with the shape of the tool hole 104, the fixing end 22 is allowed to be received by the tool hole 104, whereby a revolution limitation is produced between the internal wall of the tool hole 104 and the fixing end 22. Next, the user needs only to simply rotate the main body 10 (either directly by hand or by applying a wrench or similar tool to clamp the operating face 16 for rotating), and the distance between the enlarging section 23 and the screw end 12 is thus shortened due to the cooperation the screw hole 15 and the thread rod 21, whereby the expanding member 30 expands outward due to the enlarging section 23 pressing. As a result, the radial dimension of the expanding member 30 is increased, whereby the expanding member 30 is pressed toward the tool hole 104 (as shown in FIG. 5) and fixed in the tool hole 104.

On the other hand, when the present invention is to be removed, the user needs only to reversely rotate the main body 10, whereby the distance between the enlarging section 23 and the screw end 12 is increased, and thus enabling the expanding member 30 to restore and shrink due to the resilience thereof. As a result, the expanding member 30 is released from the tool hole 104, and the present invention is allowed to be easily removed.

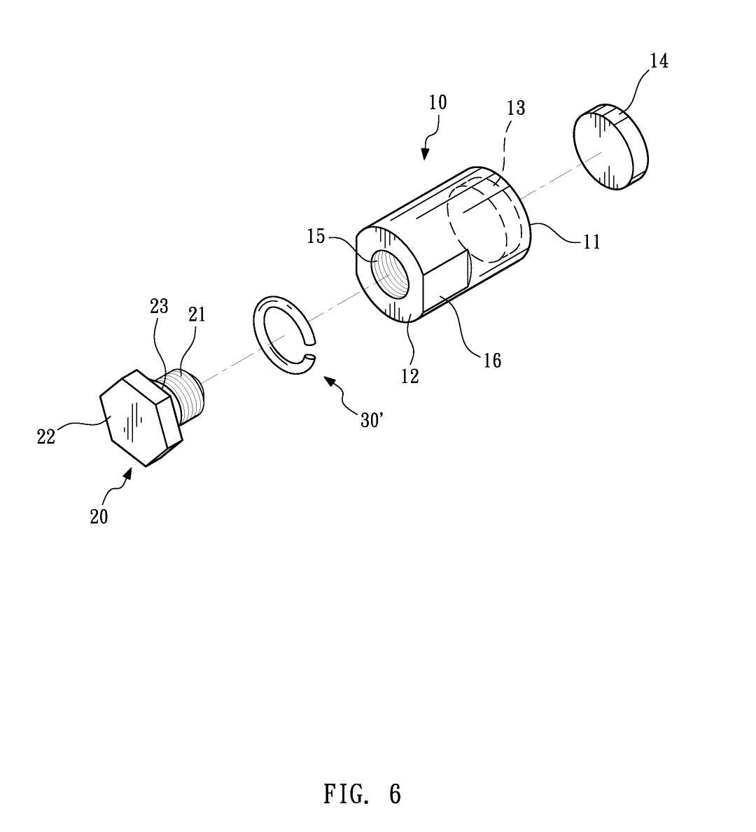

Furthermore, referring to FIG. 6, the expanding member 30′ is also allowed to be a C-shaped ring, wherein the expanding member 30′ expands or shrinks by use of resilience of the notch of the C-shaped ring, thereby achieving the same function of the previous embodiment.

With the explanation above, skilled people in the field of the present invention are allowed to understand the technical difference between the present invention and prior arts. Also, it is clear that the present invention achieves functions unachievable by prior arts. Therefore, the patentability of the present invention is assured.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A fixing device for crank sensor, comprising:
a main body, provided with a sensing end and a screw end, with a sensed member disposed on the sensing end and a screw hole axially disposed on the screw end;
a screw member, with one end thereof provided with a thread rod screwing in the screw hole and the other end provided as a fixing end, while an enlarging section is disposed between the thread rod and the fixing end; and
an expanding member, inserted on the thread rod and between the enlarging section and the screw end.

2. The device for crank sensor of claim 1, wherein the radial dimension of the enlarging section is gradually enlarged in accordance with the direction from the thread rod toward the fixing end.

3. The device for crank sensor of claim 1, wherein the fixing end is present as a polygonal shape.

4. The device for crank sensor of claim 1, wherein the fixing end is present as a hexagonal shape.

5. The device for crank sensor of claim 1, wherein the expanding member is a resilient ring.

6. The device for crank sensor of claim 1, wherein the expanding member is an O-shaped ring.

7. The device for crank sensor of claim 1, wherein the expanding member is a C-shaped ring.

8. The device for crank sensor of claim 1, wherein at least a pair of operating faces are disposed in parallel on two sides of the main body.

9. The device for crank sensor of claim 1, wherein a recess is concavely disposed on the sensing end for receiving the sensed member.

10. The device for crank sensor of claim 1, wherein the sensed member is a magnet.
